(19) United States
(12) Patent Application Publication
(10) Pub. No.: US 2026/0007111 A1
(43) Pub. Date: Jan. 8, 2026

(54) METHOD AND CONTROL SYSTEM FOR CONTROLLING A BOOM OF A FOREST WORK MACHINE

(71) Applicant: Ponsse Oyj, Vieremä (FI)

(72) Inventor: Aleksi KIVI, Vieremä (FI)

(21) Appl. No.: 18/881,185

(22) PCT Filed: Jun. 29, 2023
(86) PCT No.: PCT/FI2023/050405

§ 371 Date: Jan. 3, 2025

(30) Foreign Application Priority Data
Jul. 5, 2022 (FI) 20225631

(51) Int. Cl. A01G 23/083; A01G 23/00; A01G 23/099

(52) U.S. Cl. CPC A01G 23/083; A01G 23/003; A01G 23/099

(57) ABSTRACT

A method and a control system for controlling a boom of a forest work machine by tip control. In the method and the control system, a coordinate system of the forest work machine, a coordinate system of a work environment of the forest work machine and dependence between said coordinate systems are determined. As a response to a control command for controlling a tip of the boom of the forest work machine in motion to a target position or for keeping it in the target position in the coordinate system of the work environment, the attitude and/or state of motion of boom parts of the boom in the coordinate system of the forest work machine is determined and said control command of the tip of the boom of the forest work machine in motion is converted at least into at least one control measure of at least one actuator of the boom based on the determined attitude and/or the state of motion of the boom parts of the boom and on the dependence between the coordinate systems.

### BACKGROUND OF THE INVENTION

The invention relates to a method and a control system for controlling a boom of a forest work machine by utilizing the so-called tip control.

The boom of a forest work machine is often tended to be used simultaneously as the machine moves in order to intensify the work. However, grabbing an object is harder when the machine moves than when it is stationary. Furthermore, the faster the machine moves, the harder it is to grab the object, which increases the risk of a tool at the end of the boom of the forest work machine hitting either the ground or the object to be grabbed, whereby the forest work machine boom, tool and/or object to be grabbed can become damaged.

In addition to the above, the grabbing of an object is made difficult by using the forest work machine often in uneven terrains. When driving in an uneven terrain, the terrain can cause the forest work machine to tilt and swing in the lateral direction and/or the longitudinal direction of the forest work machine. The boom of the forest work machine is usually attached to the frame of the forest work machine via its base. Then, when the forest work machine tilts or swings, also the boom tilts or swings along the frame, whereby the height of the tool being at the end of the boom in relation to the ground increases or decreases unintentionally. This unintentional vertical movement of the tool in relation to the ground makes working even more difficult, further increasing the risk of the tool hitting either the ground or the object to be grabbed when trying to grab the object in question when the machine moves or, for example, when lowering the object being handled onto the ground.

### BRIEF DESCRIPTION OF THE INVENTION

It is the object of the invention to provide a new type of a method and control system for controlling a boom of a forest work machine when the forest work machine moves.

The arrangement according to the invention is characterised by what is disclosed in the independent claims.

In the arrangement according to the invention, a coordinate system of the forest work machine, a coordinate system of a work environment of the forest work machine and dependence between said coordinate systems are determined whereby, as a response to a control command for controlling a tip of the boom of the forest work machine in motion to a target position or for keeping it in the target position in the coordinate system of the work environment, at least the attitude and/or movement of boom parts of the boom in the coordinate system of the forest work machine is determined and said control command of the tip of the boom of the forest work machine in motion is converted at least into at least one control measure of at least one actuator of the boom based on the determined attitude and/or movement of the boom parts of the boom and the dependence between the coordinate systems.

An advantage of the solution according to the invention is that the control command for controlling the tip of the boom of the forest work machine in motion to a desired target position or for keeping it in the desired target position in the work environment of the forest work machine can be easily converted to one or more control measures affecting the attitude of the boom parts of the boom occurring in relation to the forest work machine such that the tip of the boom of the forest work machine will be directed to its target position or kept in its target position.

Some embodiments of the invention are presented in the dependent claims.

### BRIEF DESCRIPTION OF THE DRAWINGS

The invention will now be described in greater detail by means of preferred embodiments and with reference to the attached drawings, in which

FIG. 1 is a schematic view of a forwarder,

FIG. 2 is a schematic view of a harvester,

FIG. 3 is a schematic flow chart of a method for controlling the operation of a forest work machine in motion,

FIG. 4 is a schematic view of a control system of a forest work machine for controlling the operation of the forest work machine in motion,

FIG. 5 is a schematic flow chart of another method for controlling the operation of a forest work machine in motion,

FIG. 6 is a schematic view of another control system of a forest work machine for controlling the operation of the forest work machine in motion,

FIG. 7 is a schematic flow chart of an embodiment like that of FIG. 3 for controlling the operation of the forest work machine in motion,

FIG. 8 is a schematic flow chart of an embodiment like that of FIG. 5 for controlling the operation of the forest work machine in motion, and

FIG. 9 is a schematic flow chart of another embodiment like that of FIG. 5 for controlling the operation of the forest work machine in motion.

For reasons of clarity, some embodiments of the invention are illustrated in the figures in a simplified form. In the figures, like reference numerals identify like elements.

### DETAILED DESCRIPTION OF THE INVENTION

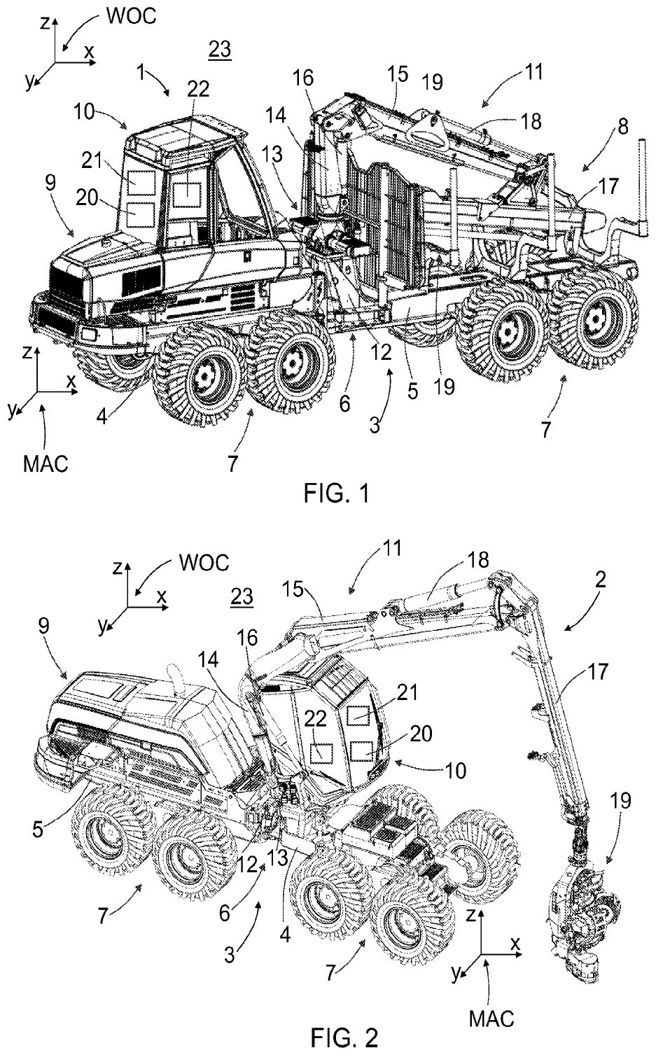

FIG. 1 is a schematic view of a forwarder 1 which constitutes a mobile forest work machine in which the above-described solution can be applied. FIG. 2 is a schematic view of a harvester 2 which constitutes another mobile forest work machine in which the above-described arrangement can be applied. The mobile forest work machine, in which the above-described solution can be applied, can also be another kind of a forwarding machine suitable for transporting loads, or a combination of a forwarder and a harvester, or a skidder equipped with a boom. The forwarder 1 shown in FIG. 1 and the harvester 2 shown in FIG. 2 are articulated steer forest work machines, but the above-described solution can also be applied in other ways, such as e.g. mobile forest work machines controllable via steerable wheels. Next, as for characteristics or embodiments examined in this description, the forwarder 1 of FIG. 1 and the harvester 2 of FIG. 2 can be referred to by their common name forest work machine, if said characteristic or embodiment being examined is not solely applicable to either the forwarder 1 or the harvester 2.

The forest work machines of FIGS. 1 and 2 comprise a chassis 3, which comprises a first frame part 4 and a second frame part 5, which are connected to each other via a link 6 such that the first frame part 4 and the second frame part 5 can rotate in relation to each other via the link 6, whereby the forest work machines in question are so-called articulated steer forest work machines. Into connection with the chassis 3 are arranged moving means 7, by means of which, the forest work machines can move in relation to their work surface. Said moving means 7 are wheels in FIGS. 1 and 2, but generally said moving means can comprise at least one of the following: wheels arranged on an axle, wheels arranged on a bogie, a track system or some other means known as such to provide the movement of the forest work machine and to possible change the direction of the movement of the forest work machine in relation to its work surface or work environment. Said moving means can further comprise one or more braking devices for decelerating the driving speed of the forest work machine or for stopping the drive of the forest work machine totally.

The forwarder 1 of FIG. 1 further includes a load space 8 arranged into connection with the second frame part 5 for taking a load to be transported by the forwarder 1. Typically, the forwarder 1 is used for transporting parts of a tree trunk typically cut to size, which are typically called logs or blocks but, in alternative use situations of the forwarder, said load can also comprise harvesting or thinning waste produced in connection with timber harvesting or forest thinning. The harvester 2 of FIG. 2 does not include said load space, the harvester 2 of FIG. 2 being thus solely intended for implementing the felling, delimbing and/or debarking of the tree and its cutting into parts of desired length.

The forest work machines of FIGS. 1 and 2 further comprise a power source 9, which in the forwarder 1 of FIG. 1 is arranged to be supported by the first frame part 4 and in the harvester 2 of FIG. 2 to be supported by the second frame part 5. The power source 9 can comprise e.g. a combustion engine, one or more electric motors and sets of batteries and/or a generator or different combinations of these for generating the required power for providing the movement of the forest work machine, for increasing its movement speed and for operating the devices arranged in the forest work machine.

The forest work machines of FIGS. 1 and 2 further comprise a cab 10, which in the forest work machines of FIGS. 1 and 2 is arranged to be supported by the first frame part 4. The cab 10 comprises required control means 20, by means of which, the operator of the forest work machine can control the drive of the forest work machine and the devices arranged in it for performing control commands to be given via said control means 20. Said control means 20 are shown very schematically in FIGS. 1 and 2 and they can comprise e.g. one or more manually controllable control means, such as e.g. a control lever, and/or one or more foot-controllable control means, such as e.g. a pedal. Said control means 20 can also comprise a pre-designed forest work machine work plan in the form of a runnable programme which is runnable by e.g. one or more forest work machine control units 21 very schematically shown in FIGS. 1 and 2 for controlling the drive of the forest work machine and the devices arranged in it. Said control unit 21 can be e.g. a computer or some other device or means comprising a microprocessor or some other microcontroller that is obvious to those skilled in the art.

The forest work machines of FIGS. 1 and 2 are typically forest work machines operating based on the active control of the operator of the forest work machine. However, it is also possible to apply the presented arrangement in both semi-autonomously operating forest work machines, whereby the forest work machine can operate at least part of the time without the active control of the operator, and in substantially totally autonomously operating forest work machines, whereby the operator does not actively contribute to the control of the forest work machine operations without a special reason. Said special reason could be e.g. such an exceptional operating situation of the forest work machine which the control unit 21 controlling the operations of the forest work machine cannot perform autonomously. In connection with semi-autonomously operating forest work machines and totally autonomously operating forest work machines, the means used for controlling the forest work machine can be located separate from the forest work machine, whereby the forest work machine does not necessarily comprise an actual cab and the control of the machine is implemented by remote control or automatically.

The forest work machines of FIGS. 1 and 2 further comprise a boom 11. The boom 11 can be supported e.g. on the chassis 3 or a separate tilting base or some other part of the machine frame. The cab 10 and/or boom 11 can be arranged foldably and/or rotatably in relation to the chassis 3. The outmost end of the boom 11 typically includes a tool 19 of the forest work machine, whereby the outmost end of the boom 11 and the tool 19 arranged to it constitute a tip of the boom. In the forwarder 1 of FIG. 1, said tool 19 typically comprises a lifting means, such as e.g. a grab or some other gripper and, in the harvester 2 of FIG. 2, said tool 19 typically comprises a wood handling tool, such as e.g. a harvester head.

In the forwarder 1 of FIG. 1, the boom 11 is constituted such that a base 12 with a turntable 13 is attached to the forwarder 1. The turntable 13 further has a lower ring and an upper ring bearing-mounted in relation to each other. The upper ring is rotated by a toothed-bar machine unit operated by hydraulic cylinders.

The boom 11 further comprises a column 14 of the boom 11. The column 14 of the boom 11 in turn has a lifting boom 15 pivoted to it. The lifting boom 15 is moved by a lifting cylinder 16.

Furthermore, a luffing boom 17 is pivoted to the lifting boom 15. The luffing boom 17 is moved by a folding cylinder 18. The outmost end of the luffing boom 17 includes the above-mentioned tool 19 of the forest work machine. The luffing boom 17 can also include a telescopic extension movable by its own actuator, whereby said tool 19 of the forest work machine is arranged to the outer end of said telescopic extension.

In the harvester of FIG. 2, the boom 11 corresponds to the boom of FIG. 1 as for its basic arrangement. However, with regard to the base 12, the boom 11 of FIG. 2 differs from the structure of FIG. 1. In the boom 11 of FIG. 2, the upper ring of the turntable or the reversal link 13 is provided with a toothing and it is rotated by a motor which rotates a toothed gear against the toothing.

The boom 11 can also be described as having, as its successive boom parts, a ring base to be rigidly connected to the forest work machine, a foot section of the boom rotatably pivoted to the ring base, a first boom pivoted to the foot section, a second boom pivoted to the first boom, and a possible telescopic arrangement in the second boom. Additionally, the boom 11 and the tool 19 arranged at its end comprise actuators, which are obvious to those skilled in the art, for using each successive boom part, i.e. for either rotating by means of said pivoting or for shortening or lengthening by means of the possible telescopic arrangement, or for using or rotating the tool and, further obvious to those skilled in the art, a sensor arrangement comprising one or more sensors for determining the attitude and/or state of motion of the boom parts of the boom and for determining the attitude and/or state of motion of the tool, wherein the state of motion of the boom part or the tool describes the speed, acceleration and/or angular velocity of the movement of the boom part or tool in question. The attitude and/or state of motion of the boom parts and/or the tool can be determined independently or in relation to a part of the boom 11 or the forest work machine frame. Said actuators can in turn be e.g. above-mentioned cylinders or other cylinders or various motors, and said sensors can be e.g. various position sensors, motion speed sensors, sensors measuring attitude, acceleration or angular velocity, pressure sensors, sensors sensing the direction of a magnetic field, or radars based on e.g. radio waves or optics, or cameras.

It will be obvious for a person skilled in the art that the forest work machine can comprise numerous additional structural and functional structure parts and entities different from the above examples, depending on the intended use and the type of the forest work machine. The forest work machine can include e.g. one or more frames, where are arranged e.g. a load space, a boom and a tool attached to it, a power source, a powertrain, control means, and moving means. The moving means can comprise e.g. a variable number of axles, the axle can be rigid, swinging or a bogie axle, to the axle or the bogie can be arranged wheels or rollers.

The presented arrangement further applies the tip control of the boom 11 for providing a desired position and possibly also desired attitude of the tip of the boom 11, i.e. the outer end of the boom 11 and the tool 19 in it, for performing a work stage. In tip control, a command is given to the tip of the boom by the control device 20 of the forest work machine, in other words, a request to move to a particular direction at a particular speed. Said control commands are converted by means of one or more control units 21 included in the control system of the forest work machine to at least one control measure of at least one actuator affecting the attitude of the boom 11 and/or at least one control measure of at least one actuator affecting the attitude of the tool 19. For each said actuator of the boom or the tool is calculated by said one or more control units 21 the required motion speed such that the combined effect of the various actuators affecting the attitude of the boom or the tool provide the desired movement of the tip of the boom and, as its result, further the end position and, if required, the desired direction of the tip of the boom 11. That is, by controlling the boom parts of the boom 11 and/or the tool 19 into a desired attitude, the desired position and direction of the tip of the boom 11 is provided.

In the tip control, the control command directed at the tip of the boom 11 by the control means for moving the tip of the boom 11 is implemented by dividing said control command to the movement of the individual boom parts of the boom 11 and/or the movement of the tool for moving the tip of the boom 11 in accordance with the control command using the attitudes and states of motion of the boom parts and/or of the tool measured by the sensors within degrees of freedom allowed by the boom parts and the tool and their actuators. The desired movement of the tip of the boom 11 is divided into parts for different boom parts and/or the tool by making use of e.g. the so-called Jacobian matrix. For implementing the tip control, guidance can be found in the following literature references, for example: Björn Löfgren: Kinematic Control of Redundant Knuckle Booms, Licentiate thesis, Department of Machine Design, Royal Institute of Technology, Stockholm, 2004; Björn Löfgren: Kinematic Control of Redundant Knuckle Booms with Automatic Path-Following Functions, Doctoral thesis, Department of Machine Design, Royal Institute of Technology, Stockholm, 2009; Mikkel M. Pedersen, Michael R. Hansen, Morten Ballebye: Developing a Tool Point Control Scheme for a Hydraulic Crane Using Interactive Real-time Dynamic Simulation: Modelling, Identification and Control, Vol. 31, No. 4, 2010, pp. 133-143, ISSN 1890-1328.

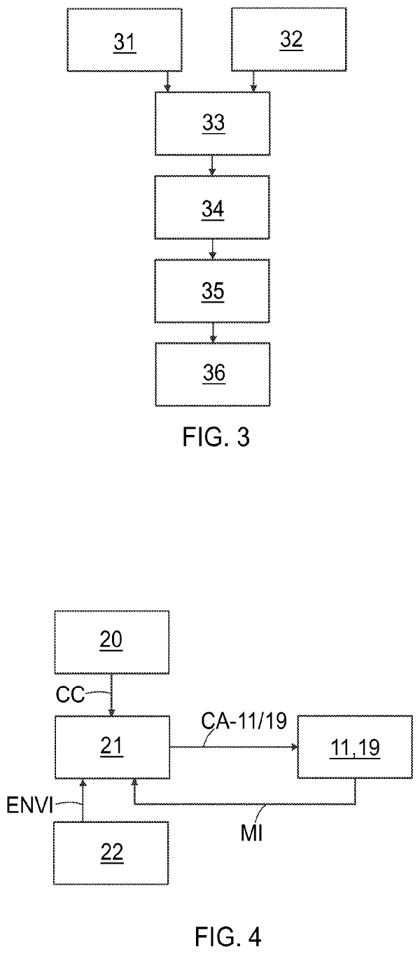

FIG. 3 is a schematic flow chart of a method for controlling a boom 11 of a forest work machine in motion. FIG. 4 is a schematic view of a control system of a forest work machine for controlling a boom 11 of the forest work machine in motion. The boom 11 is controlled by tip control for controlling the outer end of the boom 11 and the tool 19 in it, i.e. the tip of the boom 11, in a work environment of the forest work machine very schematically shown in FIGS. 1 and 2 by designation 23 i.e. the work site of the forest work machine such that the tool 19 will not hit the surface of the work environment 23 when the forest work machine moves, or such that the tool 19 can be directed in the work environment 23 to a target position or be kept in the target position when the forest work machine moves, related to which target position, the tool 19 of the forest work machine is intended to direct a specific work performance. The object of the work performance related to said target position can be e.g. a part of a felled tree trunk, i.e. a log or a block, being taken for transport in the forwarder 1, or the whole trunk, or a pile where the parts of the tree trunk transported by the forwarder 1 are piled to wait for onward transport. Alternatively, said object can be e.g. a tree which is intended to be felled, delimbed and/or debarked and cut into parts by the harvester 2. Said target position can be substantially constant during the work performances following each other, such as e.g. the pile where the trunks of felled tree trunks or their parts are piled. Said target position can also be changing, even so that the target position always changes between the work performances following each other. An example of such a changing or varying target position is a set of trees intended to be felled, where each of the trees to be felled forms a target position different from the other trees to which the tool 19 of the harvester 2 is intended to be directed in due course.

In the method of FIG. 3, in block 31, a coordinate system MAC of the forest work machine is determined, by means of which, at least the position and/or state of motion of the tip of the boom 11 of the forest work machine in relation to the forest work machine is determinable. The determination of the coordinate system MAC of the forest work machine comprises the pinning of the origin of the coordinate system MAC in question to a specific point in the forest work machine, such as e.g. to the attachment point of the turntable 13 of the base 12 of the boom 11 in the base, whereby the position and/or state of motion of the tip of the boom 11 of the forest work machine and, when needed, the direction and/or the state of motion of the tip of the boom 11 in relation to the forest work machine can be determined in relation to the attachment point of the turntable 13 of the base 12 of the boom 11.

The above definition “the position and/or state of motion of the tip of the boom 11” describes the position and/or movement of the tip in the xyz coordinate system, said movement being of the translation type. Furthermore, the above definition “the direction and/or state of motion of the tip of the boom 11” describes the direction and/or change in direction of the tip, whereby the movement corresponding said change in direction is movement of the rotation type, such as the rotation of the tool 19 in relation to one or more rotation axes.

In block 32, a coordinate system WOC of the work environment of the forest work machine is determined, by means of which, at least the position and/or state of motion of the tip of the boom 11 of the forest work machine in relation to the work environment 23 of the forest work machine and the movement of the forest work machine in relation to the work environment 23 are determinable. The determination of the coordinate system WOC of the work environment 23 of the forest work machine comprises the pinning of the origin of the coordinate system WOC in question to a specific point in the work environment 23, such as e.g. a rock in the work environment 23, whereby the position and/or state of motion of the tip of the boom 11 of the forest work machine and, when needed, the direction and/or the state of motion of the tip of the boom 11 in the work environment 23 of the forest work machine can be determined in relation to the rock in question.

The movement of the forest work machine can comprise both a translational movement component and a rotational movement component. The translational movement component comprises a movement which occurs substantially on one level, which can virtually be on the straight or in some angle in relation to a horizontal virtual reference level. For example, the run of the forest work machine forward or backward without tilting of the forest work machine in relation to any virtual axis of the forest work machine is the translational movement of the forest work machine. The rotational movement component comprises a movement which occurs by rotating in relation to some virtual axis. For example, the tilting of the forest work machine in the lateral direction and/or the longitudinal direction can be the rotational movement of the forest work machine. In practice, the movement of the forest work machine moving on an uneven surface in its work environment very often or almost always comprises both the translational movement component and the rotational movement component, and the movement of the forest work machine being substantially stationary in its work environment can comprise, as a result of the tilting of the forest work machine during work, substantially solely the rotational movement component.

In block 33, the dependence of the coordinate system MAC of the forest work machine and the coordinate system WOC of the work environment 23 of the forest work machine are determined, whereby the position and/or state of motion, and the direction and/or the state of motion, of the tip of the boom 11 of the forest work machine known in the coordinate system MAC of the forest work machine can be converted into the position and/or state of motion, and the direction and/or the state of motion, of the tip of the boom 11 known in the coordinate system WOC of the work environment of the forest work machine, or the position and/or state of motion, and the direction and/or the state of motion, of the tip of the boom 11 of the forest work machine known in the coordinate system WOC of the work environment of the forest work machine can be converted into the position and/or state of motion, and the direction and/or the state of motion, known in the coordinate system MAC of the forest work machine.

The coordinate system MAC of the forest work machine, the coordinate system WOC of the work environment 23 of the forest work machine and the dependence between said coordinate systems can be determined in the control unit 21. For the determination of the dependence between the coordinate systems, it is possible to utilize observation means 22 arranged in the forest work machine or the work environment 23, which means are suitable for indicating information related to the movement of the forest work machine, such as e.g. the advance, driving speed, driving direction, attitude and/or tilt of the forest work machine, or for observing stationary or moving objects in the work environment 23. Said observation means 22 produce situational information ENVI of the forest work machine and/or the work environment required in the determination of the dependence between the coordinate systems to the control unit 21 and the observations means 22 then form a part of the control system for controlling the boom 11 of the forest work machine. The driving speed and the driving direction of the forest work machine and other odometer information of the forest work machine can be determined based on sensor information obtained from e.g. the traction motor, traction transmission or wheels of the forest work machine or by means utilizing satellite positioning. Information on the attitude and/or tilt of the forest work machine and their speed of change in relation to the environment and thus also to the coordinate system of the environment can be determined by various position and motion sensors, such as e.g. an accelerometer, an inclinometer, a gyroscope, or a combined sensor based on sensor fusion. The means used for observing the stationary or moving objects in the work environment 23 can comprise e.g. radar, camera or laser scanning devices suitable for the purpose, known as such by those skilled in the art.

In block 34, a control command CC is produced for controlling the tip of the boom 11 of the forest work machine in motion in the coordinate system WOC of the work environment to a target position and possibly additionally to a target direction, or for keeping the tip of the boom 11 in the target position and possibly additionally in the target direction despite the movement of the forest work machine for example in a situation where there is a need to transfer the machine, the target position of the tip of the boom 11 still remaining the same. Said control command CC is produced by the control means 20 e.g. either by the operator of the forest work machine or automatically based on a predesigned work plan.

In block 35, at least the attitude and/or state of motion of the boom parts of the boom 11 are determined in relation to the coordinate system MAC of the forest work machine based on the dependence of said coordinate systems MAC, WOC. The attitude and/or the state of motion of the boom parts of the boom 11 can be determined occasionally, with regular or irregular intervals or such that the attitude and/or the state of motion of the boom parts of the boom 11 are substantially known at all times for implementing the control command CC possibly coming from the control means 20 for performing necessary control measures. Alternatively, the attitude and/or the state of motion of the boom parts of the boom 11 can be determined as a response to the control command CC coming from the control means 20 before starting the performance of the control measures necessary to implement said control command CC. Furthermore, it is also possible to determine the attitude and/or state of motion of the attitude of the tool 19 at the end of the boom 11. The attitude and/or state of motion of the boom parts of the boom 11 and the attitude and/or the state of motion of the attitude of the tool 19 can be determined in the control unit 21 based on measurement information MI received from the actuators and/or sensors of the boom 11.

In block 36, the above-mentioned control command CC of the tip of the boom 11 of the forest work machine in motion is converted into at least one control measure CA-11/19 of at least one actuator of the boom 11 based on the determined attitude of the boom 11 in the coordinate system MAC of the forest work machine and on the dependence between the coordinate systems MAC, WOC. The target position of the tip of the boom 11 in the coordinate system WOC of the work environment 23 corresponding the control command CC is converted in the control unit 21, based on the dependence between the coordinate systems MAC, WOC, into the target position of the tip of the boom 11 in the coordinate system MAC of the forest work machine, and the control unit 21 converts the control command CC of the tip of the boom 11 given in relation to the coordinate system WOC of the work environment into one or more control measures of one or more actuators affecting the attitude of the boom parts of the boom 11 to be performed in the coordinate system MAC of the forest work machine. If needed, it is also possible to affect the attitude of the tool 19 at the end of the boom 11 by one or more control measures of one or more actuators affecting the attitude of the tool 19. Designation CA-11/19 used in connection with the control measure refers to the fact that said control measure can, depending on the situation, affect either solely the actuators affecting the attitude of the boom parts of the boom 11, solely the actuators affecting the attitude of the tool 19, or them both.

In the arrangement of FIGS. 3 and 4, the control command CC for controlling the tip of the boom 11 of the forest work machine in motion to a desired target position or for keeping it in the desired target position in the work environment 23 of the forest work machine can be converted into one or more control measures affecting the attitude of the boom parts of the boom 11 and possibly the attitude of the tool 19 occurring in relation to the forest work machine such that the tip of the boom 11 of the forest work machine in motion will be directed to its target position or kept in its target position by control measures performed in the coordinate system MAC of the forest work machine.

FIGS. 3 and 4 and the above description related to them thus present an example for controlling the boom 11 of the forest work machine in motion, and the measures related to it can also be performed in a different order and with different logic. Hence, the position and/or state of motion of the tip of the boom can be determined first in the coordinate system of the work environment and, after that, in the coordinate system of the forest work machine utilizing the dependence between the coordinate systems, or the position and/or the state of motion of the tip of the boom can be first determined in the coordinate system of the forest work machine and, after that, in the coordinate system of the work environment utilizing the dependence between the coordinate systems. In the same way, the target position of the tip of the boom can be determined first in the coordinate system of the work environment and, after that, in the coordinate system of the forest work machine utilizing the dependence between the coordinate systems, or the target position can be first determined in the coordinate system of the forest work machine and, after that, in the coordinate system of the work environment utilizing the dependence between the coordinate systems.

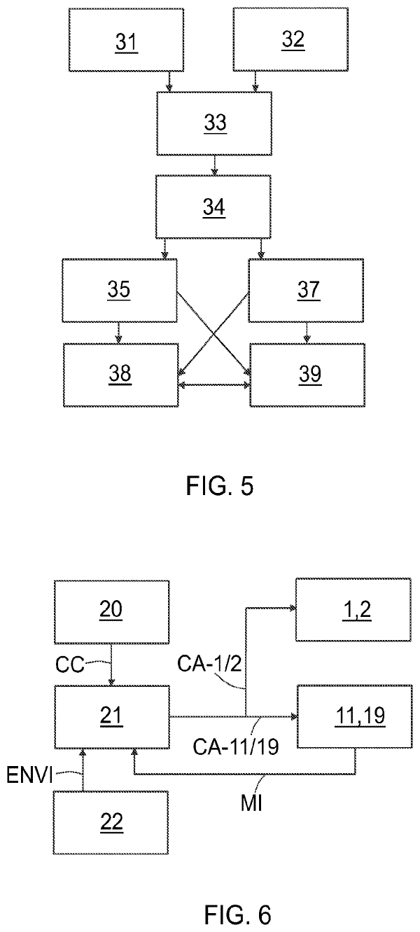

FIG. 5 is a schematic flow chart of a second method for controlling the boom 11 of the forest work machine in motion. The method of FIG. 5 corresponds to the method of FIG. 3 for most parts, but the method of FIG. 5 comprises block 38 instead of block 36 and additionally blocks 37 and 39. FIG. 6 is a schematic view of a second control system of the forest work machine for controlling the boom 11 of the forest work machine in motion.

In block 37, the movement of the forest work machine is determined in the coordinate system WOC of the work environment 23. The movement of the forest work machine in the coordinate system WOC of the work environment can be determined e.g. by means of said observation means 22 based on obtained situational information ENVI of the forest work machine and/or the work environment. In one or more other embodiments, it is also possible to determine, in addition to the movement of the forest work machine, also the location and/or attitude of the forest work machine.

The movement of the forest work machine, and in other embodiments also possibly the location and/or attitude of the forest work machine in the coordinate system MAC of the work environment 23, can be determined occasionally, with regular or irregular intervals or such that the movement, or the location and/or the attitude of the forest work machine are substantially known at all times for implementing the control command CC possibly coming from the control means for performing necessary control measures. Alternatively, the movement, location and/or attitude of the forest work machine can be determined as a response 20 to the control command CC coming from the control means 20 before starting the performance of the control measures necessary to implement said control command CC.

In block 38, the above-mentioned control command CC of the tip of the boom 11 of the forest work machine in motion is converted into at least one control measure CA-11/19 of at least one actuator of the boom 11 based on the determined attitude of the boom parts of the boom 11 in the coordinate system MAC of the forest work machine, on the determined movement of the forest work machine in the coordinate system WOC of the work environment and on the dependence between the coordinate systems MAC, WOC. The target position of the tip of the boom 11 in the coordinate system WOC of the work environment 23 corresponding the control command CC is converted in the control unit 21, based on the dependence between the coordinate systems MAC, WOC, into the target position of the tip of the boom 11 in the coordinate system MAC of the forest work machine, and the control unit 21 is further configured to convert the control command CC of the tip of the boom 11 given in relation to the coordinate system WOC of the work environment into one or more control measures CA-11/19 of one or more actuators affecting the attitude of the boom parts of the boom 11 to be performed in the coordinate system MAC of the forest work machine. If needed, it is also possible to affect the attitude of the tool 19 at the end of the boom 11 by one or more control measures of one or more actuators affecting the position of the tool 19.

In block 39, the control command CC of the tip of the boom 11 of the forest work machine in motion is also converted into at least one control measure CA-1/2 controlling the movement of the forest work machine based on the determined attitude of the boom parts of the boom 11 in the coordinate system MAC of the forest work machine, on the determined movement of the forest work machine in the coordinate system WOC of the work environment and on the dependence between the coordinate systems MAC, WOC, considering the target position of the tip of the boom 11 in the coordinate system MAC of the forest work machine determined in block 38. Then, the control unit 21 is configured to convert the control command CC of the tip of the boom 11 given in relation to the coordinate system

WOC of the work environment also to one or more control measures CA-1/2 performed in the coordinate system WOC of the work environment, which affect the movement of the forest work machine, i.e. in practice the driving direction and driving speed of the forest work machine, such that the target position of the tip of the boom 11 corresponding the control command CC can be reached or the tip of the boom 11 can be kept in the target position by affecting in addition to the boom parts of the boom 11 also the movement of the forest work machine, i.e. the driving direction and driving speed of the forest work machine. Designation CA-1/2 used in connection with the control measure in question refers to the forest work machine being either a forwarder 1, a harvester 2 or their combination.

In the solution of FIGS. 5 and 6, there are both block 38, where the control command CC of the tip of the boom 11 of the forest work machine in motion is converted into at least one control measure CA-11/19 of at least one actuator of the boom 11 in the coordinate system MAC of the forest work machine, and block 39, where the control command CC of the tip of the boom 11 of the forest work machine in motion is also converted into at least one control measure CA-1/2 controlling the movement of the forest work machine in the coordinate system WOC of the work environment. In this case, said control command CC of the tip of the boom 11 can be implemented by controlling both the position of the tip of the boom 11 and the movement of the forest work machine.

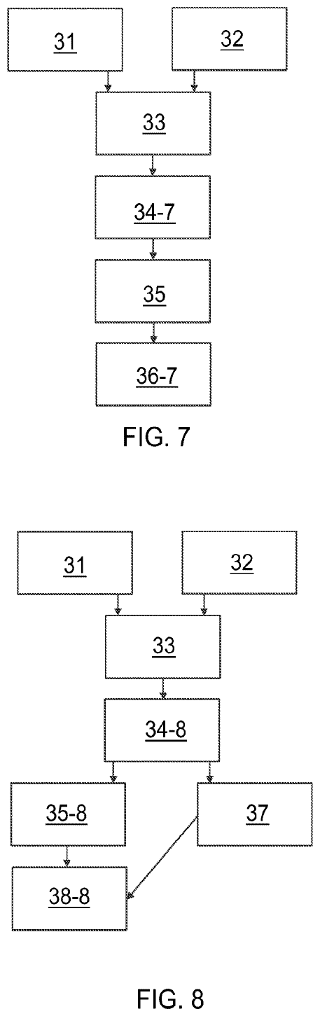

FIGS. 5 and 6 and the above description related to them thus present a second example for controlling the boom 11 of the forest work machine in motion, and the measures related to it can also be performed in a different order and with different logic. Hence, the position and/or state of motion of the tip of the boom can be determined first in the coordinate system of the work environment and, after that, in the coordinate system of the forest work machine utilizing the dependence between the coordinate systems, or the position and/or the state of motion of the tip of the boom can be first determined in the coordinate system of the forest work machine and, after that, in the coordinate system of the work environment utilizing the dependence between the coordinate systems. In the same way, the target position of the tip of the boom can be determined first in the coordinate system of the work environment and, after that, in the coordinate system of the forest work machine utilizing the dependence between the coordinate systems, or the target position can be first determined in the coordinate system of the forest work machine and, after that, in the coordinate system of the work environment utilizing the dependence between the coordinate systems. FIG. 7 is a schematic flow chart of an embodiment like that of FIG. 3 for controlling the boom 11 of the forest work machine in motion. FIG. 7 is a schematic view of block 34-7, which is arranged to replace block 34 in FIG. 3, and block 36-7, which is arranged to replace block 36 of FIG. 3. As for the other blocks, the embodiment of FIG. 7 substantially equals the embodiment of FIG. 3.

In block 34-7, a control command is produced for controlling the tip of the boom 11 of the forest work machine in motion to a target position in the coordinate system WOC of the work environment into a substantially unchanged position in the vertical direction. Said control command CC is produced by the control means 20 e.g. either by the operator of the forest work machine or automatically based on a predesigned work plan, the purpose being to keep the tool 19 of the boom 11 in the coordinate system WOC of the work environment substantially at a constant distance from the surface of the work environment 23 in the vertical direction.

In block 36-7, the control command CC of the tip of the boom 11 is converted via the control unit 21 into at least one control measure CA-11/19 of at least one actuator controlling the tip of the boom 11 in at least one degree of freedom of the tip of the boom 11 for keeping the tip of the boom 11 via at least one change in attitude of at least one boom part of the boom 11 in the coordinate system WOC of the work environment substantially in an unchanged position in the vertical direction. The target position of the tip of the boom 11 in the coordinate system WOC of the work environment 23 corresponding the control command CC is converted in the control unit 21, based on the dependence between the coordinate systems MAC, WOC, into the target position of the tip of the boom 11 in the coordinate system MAC of the forest work machine. The attitude of the tool 19 can be kept constant or the attitude of the tool 19 can be changed e.g. in a situation where the changing of the attitude of the tool 19 minimizes the control measures required for controlling the boom parts of the boom 11.

The embodiment of FIG. 7 is applicable for use in both a forwarder 1 and a harvester 2 for compensating the swinging of the boom 11 and the tool 19 at its end caused by the cross-directional or longitudinal tilting of the forwarder 1 or the harvester 2, keeping the tool 19 substantially at a constant distance from the ground such that the tool 19 cannot hit the ground. Because in the embodiment of FIG. 7 it is not necessary to consider the driving direction or the driving speed of the forest work machine for controlling the tip of the boom 11, the embodiment of FIG. 7 is also applicable for use for controlling the position of the tip of the boom 11 in a stationary forest work machine, in which cross-directional or longitudinal swinging or tilting can occur as a result of e.g. the dynamic tilting of the machine, the transfer of the load, or the depression or yielding of the surface of the work environment 23. If the highest movement speed or dynamics of the actuators of the boom 11 or the general performance of the boom 11 is not sufficient for compensating the swinging or tilting of the machine, the driving speed of the forest work machine can be limited and thus also actively affect the movement of the forest work machine.

FIG. 7 and the above description related to it thus present a third example for controlling the boom 11 of the forest work machine in motion, and the measures related to it can also be performed in a different order and with different logic. Hence, the position and/or state of motion of the tip of the boom can be determined first in the coordinate system of the work environment and, after that, in the coordinate system of the forest work machine utilizing the dependence between the coordinate systems, or the position and/or the state of motion of the tip of the boom can be first determined in the coordinate system of the forest work machine and, after that, in the coordinate system of the work environment utilizing the dependence between the coordinate systems. In the same way, the target position of the tip of the boom can be determined first in the coordinate system of the work environment and, after that, in the coordinate system of the forest work machine utilizing the dependence between the coordinate systems, or the target position can be first determined in the coordinate system of the forest work machine and, after that, in the coordinate system of the work environment utilizing the dependence between the coordinate systems.

FIG. 8 is a schematic flow chart of an embodiment like that of Figure for controlling the boom 11 of the forest work machine in motion, FIG. 8 schematically shows block 34-8, which is arranged to replace block 34 of FIG. 5, block 35-8, which is arranged to replace block 35 of FIG. 5, and block 38-8, which is arranged to replace block 38 of FIG. 5. FIG. 8 does not show a block corresponding block 39 of FIG. 5 because it is not necessary in the embodiment of FIG. 8. As for the other blocks, the embodiment of FIG. 8 substantially equals the embodiment of FIG. 5.

In block 34-8, a control command is produced for controlling the tip of the boom 11 of the forest work machine in motion into a stationary object in the coordinate system WOC of the work environment which object forms the target position for the tip of the boom 11. Said control command CC is produced by the control means 20 e.g. either by the operator of the forest work machine or automatically based on a predesigned work plan.

In block 35-8, the following are determined by the control unit 21:
at least the position and/or state of motion of the tip of the boom 11 in the coordinate system WOC of the work environment, the tip of the boom 11 being at a distance from said stationary object,
at least the position and/or state of motion of the tip of the boom 11 in the coordinate system MAC of the forest work machine based on the dependence between the coordinate systems MAC, WOC, the tip of the boom 11 being at said distance from said stationary object, and
at least the attitude and/or state of motion of the boom parts of the boom 11 at least in the coordinate system MAC of the forest work machine based at least on the position of the tip of the boom 11 in the coordinate system MAC of the forest work machine.

In block 38-8, the control command CC for controlling the tip of the boom 11 to said stationary object is converted by the control unit 21 into at least one control measure CA-11/19 of at least one actuator controlling the tip of the boom 11 in at least one degree of freedom in the coordinate system of the forest work machine MAC for controlling of the tip of the boom 11 to said stationary object based on the determined movement of the forest work machine in the coordinate system WOC of the work environment, the determined attitude and/or the state of motion of the boom parts of the boom 11 in the coordinate system MAC of the forest work machine, and on the dependence between the coordinate systems MAC, WOC.

In the embodiment of FIG. 8, the tip of the boom 11 is controlled to said stationary object thus solely by changing the attitude of the boom parts of the boom 11. The attitude of the tool 19 can be kept constant depending on the embodiment or, additionally, the attitude of the tool 19 can be changed.

FIG. 8 and the above description related to it thus present a fourth example for controlling the boom 11 of the forest work machine in motion, and the measures related to it can also be performed in a different order and with different logic. Hence, the position and/or state of motion of the tip of the boom can be determined first in the coordinate system of the work environment and, after that, in the coordinate system of the forest work machine utilizing the dependence between the coordinate systems, or the position and/or the state of motion of the tip of the boom can be first determined in the coordinate system of the forest work machine and, after that, in the coordinate system of the work environment utilizing the dependence between the coordinate systems. In the same way, the target position of the tip of the boom can be determined first in the coordinate system of the work environment and, after that, in the coordinate system of the forest work machine utilizing the dependence between the coordinate systems, or the target position can be first determined in the coordinate system of the forest work machine and, after that, in the coordinate system of the work environment utilizing the dependence between the coordinate systems.

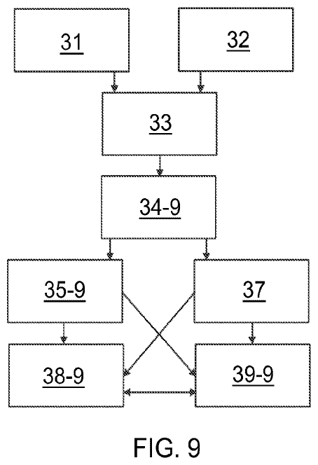

FIG. 9 is a schematic flow chart of another embodiment like that of FIG. 5 for controlling the boom 11 of the forest work machine in motion, Compared with FIG. 8, FIG. 9 schematically shows block 34-9, which is arranged to implement the operation of block 34-8 of FIG. 8, block 35-9, which is arranged to implement the operation of block 35-8 of FIG. 8, and block 38-9, which is arranged to implement the operation of block 38-8 of FIG. 8. Compared with FIG. 8, FIG. 9 also comprises block 39-9. As for the other blocks, the embodiment of FIG. 9 substantially equals the embodiment of FIG. 5.

In block 38-9, the control command CC for controlling the tip of the boom 11 to said stationary object is converted by the control unit 21 both into at least one control measure CA-11/19 of at least one actuator controlling the tip of the boom 11 in at least one degree of freedom in the coordinate system MAC of the forest work machine and at least one control measure CA-1/2 controlling of movement of the forest work machine in the coordinate system WOC of the work environment based on the determined movement of the forest work machine in the coordinate system WOC of the work environment, the determined attitude of the boom parts of the boom 11 in the coordinate system MAC of the forest work machine, and on the dependence between the coordinate systems MAC, WOC.

In the embodiment of FIG. 9, the tip of the boom 11 is controlled to said stationary object both by changing the attitude and/or direction of the boom parts of the boom 11 and the movement, i.e. the driving direction and/or driving speed, of the forest work machine.

FIG. 9 and the above description related to it thus present a fifth example for controlling the boom 11 of the forest work machine in motion, and the measures related to it can also be performed in a different order and with different logic. Hence, the position and/or state of motion of the tip of the boom, and possibly also the direction and/or state of motion of the tip of the boom, can be determined first in the coordinate system of the work environment and, after that, in the coordinate system of the forest work machine utilizing the dependence between the coordinate systems, or the position and/or the state of motion, and possibly also the direction and/or the state of motion, of the tip of the boom can be first determined in the coordinate system of the forest work machine and, after that, in the coordinate system of the work environment utilizing the dependence between the coordinate systems. In the same way, the target position of the tip of the boom can be determined first in the coordinate system of the work environment and, after that, in the coordinate system of the forest work machine utilizing the dependence between the coordinate systems, or the target position can be first determined in the coordinate system of the forest work machine and, after that, in the coordinate system of the work environment utilizing the dependence between the coordinate systems.

According to an embodiment like that of FIG. 8 or like that of FIG. 9, the control means 21 are configured to produce a control command CC for controlling the tip of the boom 11 of the forest work machine in motion for grabbing an object stationary in the coordinate system WOC of the work environment or, alternatively, the control means 21 are configured to produce a control command CC for controlling the tip of the boom 11 of the forest work machine in motion in the coordinate system WOC of the work environment for leaving a load at the tip of the boom to a site stationary in the coordinate system of the work environment. In these embodiments,
determining the position and/or state of motion of the tip of the boom 11 and additionally the direction and/or the state of motion of the tip of the boom 11 in the coordinate system WOC of the work environment, the tip of the boom 11 being at a distance from said stationary object,
determining the position and/or state of motion of the tip of the boom 11, and additionally the direction and/or the state of motion of the tip of the boom 11 in the coordinate system MAC of the forest work machine based on the dependence between the coordinate systems MAC, WOC, and the position and/or the state of motion of the tip of the boom 11, and additionally the direction and/or the state of motion of the tip of the boom 11 in the coordinate system WOC of the work environment, the tip of the boom 11 being at said distance from said stationary object,
determining the attitude and/or state of motion of the boom parts of the boom 11 and the attitude and/or state of motion of the tool 19 at the end of the boom 11 at least in the coordinate system MAC of the forest work machine based on the determined position and/or the state of motion of the tip of the boom 11, and additionally the direction and/or state of motion of the tip of the boom 11 in the coordinate system MAC of the forest work machine, and
converting the control command CC into at least one control measure CA-11/19 of at least one actuator controlling the attitude of the boom 11 and/or the tool 19 in at least one degree of freedom in the coordinate system of the forest work machine MAC and/or at least one control measure CA-1/2 controlling of movement of the forest work machine in the coordinate system WOC of the work environment based on the determined movement of the forest work machine, the determined attitude and/or the state of motion of the boom parts of the boom 11, the attitude and/or the state of motion of the tool 19, and on the dependence between the coordinate systems MAC, WOC. In connection with a forwarder 1, said embodiments can be applied e.g. for grabbing one or more logs on the ground or for lowering a load or a haul at the tip of the boom 11 onto the ground or into a pile when the forwarder 1 moves. In connection with a harvester 2, said embodiments can be applied e.g. for grabbing a tree to be felled or for lowering a load or a haul at the tip of the boom 11 onto the ground or into a pile or sawing a log onto the ground or into the pile when the harvester 2 moves.

According to an embodiment like the one of FIG. 8 or an embodiment like the one of FIG. 9, the control means 21 are configured to produce a control command CC for transferring the forest work machine in motion in the work environment keeping the tip of the boom 11 supported on an object being stationary in the work environment 23, such as the ground or some other solid object. In this embodiment,
determining at least the position of the tip of the boom 11 in the coordinate system WOC of the work environment, the tip of the boom 11 being supported on said stationary object,
determining at least the position of the tip of the boom 11 in the coordinate system MAC of the forest work machine based on the dependence between the coordinate systems MAC, WOC and the position of the tip of the boom 11 in the coordinate system WOC of the work environment, the tip of the boom 11 being supported on said stationary object,
determining at least the attitude of the boom parts of the boom 11 in the coordinate system MAC of the forest work machine based on the position of the tip of the boom 11 in the coordinate system WOC of the work environment,
determining the movement of the forest work machine in the coordinate system of the work environment WOC, and
converting the control command CC into at least one control measure CA-11/19 of at least one actuator controlling the tip of the boom 11 in at least one degree of freedom in the coordinate system of the forest work machine MAC and/or at least one control measure CA-1/2 controlling the movement of the forest work machine in the coordinate system WOC of the work environment based on the determined attitude of the boom parts of the boom 11, the determined movement of the forest work machine and on the dependence between the coordinate systems MAC, WOC.

In the embodiment, the forest work machine in motion can be transferred in the work environment 23 by means of a change in the attitude of the boom 11 and/or by means of a change in the movement of the forest work machine keeping the tip of the boom 11 supported on the ground or some other solid object. This embodiment can be utilized e.g. when the tool 19 at the end of the boom 11 has not yet grabbed the object in question but the position of the tool 19 is still allowed to change.

According to an embodiment like the one of FIG. 8 or an embodiment like the one of FIG. 9, the control means 21 are configured to produce a control command CC for transferring the forest work machine in motion in the work environment keeping the tip of the boom 11 grabbing an object being stationary in the work environment 23, such as a standing tree or a tree stump, without substantially changing the attitude of the tool 19 at the end of the boom 11. In this embodiment,
determining the position and direction of the tip of the boom 11 in the coordinate system WOC of the work environment, the tip of the boom 11 grabbing said stationary object,
determining the position and direction of the tip of the boom in the coordinate system MAC of the forest work machine based on the dependence between the coordinate systems MAC, WOC and the position and direction of the tip of the boom 11 in the coordinate system WOC of the work environment, the tip of the boom 11 grabbing said stationary object,
determining the attitude of the boom parts of the boom 11 and the attitude of the tool 19 in the coordinate system MAC of the forest work machine based on the determined position and direction of the tip of the boom 11 in the coordinate system MAC of the forest work machine,
determining the movement of the forest work machine in the coordinate system of the work environment WOC, and
converting the control command CC into at least one control measure CA-11/19 of at least one actuator controlling the tip of the boom 11 in at least one degree of freedom in the coordinate system of the forest work machine MAC and/or at least one control measure CA-1/2 controlling the movement of the forest work machine in the coordinate system WOC of the work environment based on the determined attitude of the boom parts of the boom 11 and the attitude of the tool 19, the determined movement of the forest work machine and on the dependence between the coordinate systems MAC, WOC.

In this embodiment, the forest work machine in motion can be transferred in the work environment 23 by means of a change in the attitude of the boom 11 and/or by means of a change in the movement of the forest work machine keeping the tip of the boom 11 grabbing said stationary object without substantially changing the attitude of the tool 19 at the end of the boom 11. This embodiment can be utilized e.g. when the tool 19 at the end of the boom 11 has grabbed the object in question and the attitude of the tool 19 should not substantially change any more.

Said embodiments applicable for transferring the forest work machine in motion can be utilized for transferring the forest work machine e.g. when the tool 19 is grabbing a tree to be felled or an already felled trunk or its part, or when the tool 19 has already grabbed the tree being felled or the already felled trunk or its part. Then, the forest work machine can be easily transferred by means of a change in the attitude of the boom 11 and/or by means of a change in the movement of the forest work machine closer towards the object or farther away from the object which is being grabbed or which has already been grabbed or, alternatively, transfer the forest work machine, said object being on the side of the forest work machine. The embodiments in question can also be used for transferring the forest work machine when trying to eliminate or decrease the overturning moment directed at the forest work machine caused by the disadvantageous attitude of the forest work machine. When transferring the forest work machine which has already grabbed the object in the way described here, the movement of the forest work machine can still be limited such that the dimension of the boom 11 is not exceeded.

Those skilled in the art will find it obvious that, as technology advances, the basic idea of the invention may be implemented in many different ways. The invention and its embodiments are thus not restricted to the examples described above but can vary within the scope of the claims. The forest work machines of FIGS. 1 and 2 each include only one boom, but the presented arrangement can naturally be also applied in forest work machines equipped with two or more booms. The two or more booms can be considered to be used particularly in forest work machines operating semi-autonomously or substantially totally autonomously, whereby the forest work machine has more space and load carrying capacity when it is possible to omit the cab from the forest machine.

1. A method for controlling a boom of a forest work machine by tip control, in which method
determining a coordinate system of the forest work machine, by means of which, at least the position and/or state of motion of a tip of the boom of the forest work machine in relation to the forest work machine is determinable,
determining a coordinate system of a work environment of the forest work machine, by means of which, at least the position and/or state of motion of the tip of the boom of the forest work machine and the movement of the forest work machine in relation to the work environment are determinable,
determining the dependence of said coordinate systems,
producing a control command for controlling the tip of the boom of the forest work machine in motion to a target position or for keeping it in the target position in the coordinate system of the work environment,
determining at least the attitude and/or state of motion of boom parts of the boom in the coordinate system of the forest work machine, and
converting said control command of the tip of the boom of the forest work machine in motion at least into at least one control measure of at least one actuator of the boom based on the determined attitude and/or state of motion of the boom parts of the boom and the dependence between the coordinate systems.

2. A method according to claim 1, comprising
determining further the movement of the forest work machine in the coordinate system of the work environment, and
converting the control command of the tip of the boom into both at least one control measure of at least one actuator of the boom and at least one control measure controlling the movement of the forest work machine based on the determined attitude and/or state of motion of the boom parts of the boom, the determined movement of the forest work machine and the dependence between the coordinate systems.

3. A method according to claim 1, comprising
producing a control command for controlling the tip of the boom of the forest work machine in motion to a substantially unchanged position in the vertical direction in the coordinate system of the work environment, and by
converting the control command of the tip of the boom into at least one control measure of at least one actuator controlling the tip of the boom in at least one degree of freedom in the coordinate system of the forest work machine for keeping the tip of the boom via at least one change in attitude of at least one boom part of the boom in the coordinate system of the work environment in a substantially unchanged position in the vertical direction.

4. A method according to claim 1, comprising producing a control command for controlling the tip of the boom of the forest work machine in motion to an object being stationary in the coordinate system of the work environment, whereby the method comprises
determining at least the position and/or state of motion of the tip of the boom in the coordinate system of the work environment, the tip of the boom being at a distance from said stationary object,
determining at least the position and/or state of motion of the tip of the boom in the coordinate system of the forest work machine, the tip of the boom being at said distance from said stationary object,
determining at least the attitude and/or state of motion of at least the boom parts of the boom in the coordinate system of the forest work machine based on at least the determined position and/or the state of motion of the tip of the boom in the coordinate system of the forest work machine,
determining the movement of the forest work machine in the coordinate system of the work environment, and
converting the control command for controlling the tip of the boom to said stationary object into at least one control measure of at least one actuator controlling the tip of the boom in at least one degree of freedom in the coordinate system of the forest work machine for controlling of the tip of the boom to said stationary object based on the determined movement of the forest work machine, the determined attitude and/or the state of motion of the boom parts of the boom, and on the dependence between the coordinate systems.

5. A method according to claim 4, comprising converting the control command for controlling the tip of the boom to said stationary object both into at least one control measure of at least one actuator controlling the tip of the boom in at least one degree of freedom in the coordinate system of the forest work machine and at least one control measure controlling the movement of the forest work machine in the coordinate system of the work environment based on the determined movement of the forest work machine, the determined attitude and/or state of motion of the boom parts of the boom, and on the dependence between the coordinate systems.

6. A method according to claim 4, comprising producing a control command for controlling the tip of the boom of the forest work machine in motion to grab an object being stationary in the coordinate system of the work environment, whereby the method comprises
determining the position and/or state of motion and additionally the direction and/or the state of motion of the tip of the boom in the coordinate system of the work environment, the tip of the boom being at a distance from said stationary object,
determining the position and/or state of motion and additionally the direction and/or the state of motion of the tip of the boom in the coordinate system of the forest work machine, the tip of the boom being at said distance from said stationary object,
determining the attitude and/or state of motion of the boom parts of the boom and additionally the attitude and/or state of motion of the tool at the end of the boom at least in the coordinate system of the forest work machine based on the determined position and/or the state of motion of the tip of the boom, and additionally the direction and/or state of motion of the tip of the boom in the coordinate system of the forest work machine, and
converting the control command into at least one control measure of at least one actuator controlling the attitude of the boom and/or the tool in at least one degree of freedom in the coordinate system of the forest work machine and/or at least one control measure controlling of movement of the forest work machine in the coordinate system of the work environment based on the determined movement of the forest work machine, the determined attitude and/or the state of motion of the boom parts of the boom, the attitude and/or the state of motion of the tool, and on the dependence between the coordinate systems.

7. A method according to claim 4, comprising producing a control command for controlling the tip of the boom of the forest work machine in motion in the coordinate system of the work environment to leave a load at the tip of the boom to a site being stationary in the coordinate system of the work environment, whereby the method comprises
determining the position and/or state of motion and additionally the direction and/or the state of motion of the tip of the boom in the coordinate system of the work environment, the tip of the boom being at a distance from said stationary object,
determining the position and/or state of motion and additionally the direction and/or the state of motion of the tip of the boom in the coordinate system of the forest work machine, the tip of the boom being at said distance from said stationary object,
determining the attitude and/or state of motion of the boom parts of the boom and the attitude and/or state of motion of the tool at the end of the boom at least in the coordinate system of the forest work machine based on the determined position and/or the state of motion of the tip of the boom, and additionally the direction and/or state of motion of the tip of the boom in the coordinate system of the forest work machine, and
converting the control command into at least one control measure of at least one actuator controlling the attitude of the boom and/or the tool in at least one degree of freedom in the coordinate system of the forest work machine and/or at least one control measure controlling of movement of the forest work machine in the coordinate system of the work environment based on the determined movement of the forest work machine, the determined attitude and/or the state of motion of the boom parts of the boom, the attitude and/or the state of motion of the tool, and on the dependence between the coordinate systems.

8. A method according to claim 4, comprising producing a control command for transferring the forest work machine in motion in the coordinate system of the work environment, keeping the tip of the boom supported to said stationary object, whereby the method comprises
determining at least the position of the tip of the boom in the coordinate system of the work environment, the tip of the boom being supported on said stationary object,
determining at least the position of the tip of the boom in the coordinate system of the forest work machine, the tip of the boom being supported on said stationary object,
determining at least the attitude of the boom parts of the boom in the coordinate system of the forest work machine based on the determined position of the tip of the boom in the coordinate system of the forest work machine,
determining the movement of the forest work machine in the coordinate system of the work environment, and
converting the control command into at least one control measure of at least one actuator controlling the tip of the boom in at least one degree of freedom in the coordinate system of the forest work machine and/or at least one control measure controlling the movement of the forest work machine in the coordinate system of the work environment based on the determined attitude of the boom parts of the boom, the determined movement of the forest work machine and on the dependence between the coordinate systems.

9. A method according to claim 4, comprising producing a control command for transferring the forest work machine in motion in the coordinate system of the work environment, keeping the tip of the boom grabbing said stationary object without substantially changing the attitude of the tool at the end of the boom, whereby the method comprises
determining the position and direction of the tip of the boom in the coordinate system of the work environment, the tip of the boom grabbing said stationary object,
determining the position and direction of the tip of the boom in the coordinate system of the forest work machine, the tip of the boom grabbing said stationary object,
determining the attitude of the boom parts of the boom and the attitude of the tool in the coordinate system of the forest work machine based on the determined position and direction of the tip of the boom in the coordinate system of the forest work machine,
determining the movement of the forest work machine in the coordinate system of the work environment, and
converting the control command into at least one control measure of at least one actuator controlling the tip of the boom in at least one degree of freedom in the coordinate system of the forest work machine and/or at least one control measure controlling the movement of the forest work machine in the coordinate system of the work environment based on the determined attitude of the boom parts of the boom and the attitude of the tool, the determined movement of the forest work machine and on the dependence between the coordinate systems.

10. A control system for controlling a boom of a forest work machine by tip control, the control system comprising
at least one control unit which is configured to determine a coordinate system of the forest work machine, a coordinate system of a work environment of the forest work machine and dependence between said coordinate systems, whereby the control unit is configured to determine at least the position and/or state of motion of a tip of the boom of the forest work machine in relation to the forest work machine in the coordinate system of the forest work machine, the position and/or state of motion of the tip of the boom of the forest work machine in relation to the work environment in the coordinate system of the work environment and the movement of the forest work machine in the coordinate system of the work environment,
at least one control means for producing a control command for controlling the tip of a boom of the forest work machine in motion to a target position in the coordinate system of the work environment,
sensors for determining the attitude and/or state of motion of the boom parts of the boom and the attitude of the tool at the end of the boom at least in the coordinate system of the forest work machine, and
actuators for changing the attitude of the boom parts of the boom and the attitude of the tool, and wherein
said at least one control unit is further configured to convert said control command of the tip of the boom of the forest work machine in motion at least into at least one control measure of at least one actuator of the boom based on the determined attitude and/or the state of motion of the boom parts of the boom and the dependence between the coordinate systems.

11. A control system according to claim 10, wherein
said at least one control unit is further configured to determine the movement of the forest work machine in the coordinate system of the work environment, and
to convert the control command of the tip of the boom into both at least one control measure of at least one actuator of the boom and at least one control measure controlling the movement of the forest work machine based on the determined attitude and/or the state of motion of the boom parts of the boom, the determined movement of the forest work machine and the dependence between the coordinate systems.

12. A control system according to claim 10, wherein
said at least one control means is configured to produce a control command for controlling the tip of the boom of the forest work machine in motion to a target position or for keeping it in the target position in the coordinate system of the work environment, and that
said at least one control unit is configured to convert the control command of the tip of the boom into at least one control measure of at least one actuator controlling the tip of the boom in at least one degree of freedom in the coordinate system of the forest work machine for keeping the tip of the boom via at least one change in attitude of at least one boom part of the boom in the coordinate system of the work environment substantially in an unchanged position in the vertical direction.

13. A control system according to claim 10, wherein said at least one control means is configured to produce a control command for controlling the tip of the boom of the forest work machine in motion to an object being stationary in the coordinate system of the work environment, whereby said at least one control unit is configured to:
determine at least the position and/or state of motion of the tip of the boom in the coordinate system of the work environment, the tip of the boom being at a distance from said stationary object,
determine at least the position and/or state of motion of the tip of the boom in the coordinate system of the forest work machine, the tip of the boom being at said distance from said stationary object,
determine at least the attitude and/or state of motion of the boom parts of the boom in the coordinate system of the forest work machine based on at least the determined position and/or state of motion of the tip of the boom in the coordinate system of the forest work machine,
determine the movement of the forest work machine in the coordinate system of the work environment, and
convert the control command for controlling the tip of the boom to said stationary object into at least one control measure of at least one actuator controlling the tip of the boom in at least one degree of freedom in the coordinate system of the forest work machine for controlling of the tip of the boom to said stationary object based on the determined movement of the forest work machine, the determined attitude and/or the state of motion of the boom parts of the boom, and on the dependence between the coordinate systems.

14. A control system according to claim 13, wherein said at least one control unit is configured to convert the control command for controlling the tip of the boom to said stationary object both into at least one control measure of at least one actuator controlling the tip of the boom in at least one degree of freedom in the coordinate system of the forest work machine and at least one control measure controlling the movement of the forest work machine in the coordinate system of the work environment based on the determined movement of the forest work machine, the determined attitude and/or state of motion of the boom parts of the boom, and on the dependence between the coordinate systems.

15. A control system according to claim 13,
wherein said at least one control means is configured to produce a control command for controlling the tip of the boom of the forest work machine in motion for grabbing an object being stationary in the coordinate system of the work environment, whereby said at least one control unit is configured to
determine the position and/or state of motion and additionally the direction and/or the state of motion of the tip of the boom in the coordinate system of the work environment, the tip of the boom being at a distance from said stationary object,
determine the position and/or state of motion and additionally the direction and/or the state of motion of the tip of the boom in the coordinate system of the forest work machine, the tip of the boom being at said distance from said stationary object,
determine the attitude and/or state of motion of the boom parts of the boom and the attitude and/or state of motion of the tool at the end of the boom at least in the coordinate system of the forest work machine based on the determined position and/or the state of motion of the tip of the boom, and additionally the direction and/or state of motion of the tip of the boom in the coordinate system of the forest work machine, and
convert the control command into at least one control measure of at least one actuator controlling the attitude of the boom and/or the tool in at least one degree of freedom in the coordinate system of the forest work machine and/or at least one control measure controlling of movement of the forest work machine in the coordinate system of the work environment based on the determined movement of the forest work machine, the determined attitude and/or the state of motion of the boom parts of the boom, the attitude and/or the state of motion of the tool, and on the dependence between the coordinate systems.

16. A control system according to claim 13,
wherein said at least one control means is configured to produce a control command for controlling the tip of the boom of the forest work machine in motion in the coordinate system of the work environment for leaving a load at the tip of the boom at a site being stationary in the coordinate system of the work environment, whereby said at least one control unit is configured to
determine the position and/or state of motion and additionally the direction and/or the state of motion of the tip of the boom in the coordinate system of the work environment, the tip of the boom being at a distance from said stationary object,
determine the position and/or state of motion and additionally the direction and/or the state of motion of the tip of the boom in the coordinate system of the forest work machine, the tip of the boom being at said distance from said stationary object,
determine the attitude and/or state of motion of the boom parts of the boom and the attitude and/or state of motion of the tool at the end of the boom at least in the coordinate system of the forest work machine based on the determined position and/or the state of motion of the tip of the boom, and additionally the direction and/or state of motion of the tip of the boom in the work environment of the forest work machine, and
convert the control command into at least one control measure of at least one actuator controlling the attitude of the boom and/or the tool in at least one degree of freedom in the coordinate system of the forest work machine and/or at least one control measure controlling of movement of the forest work machine in the coordinate system of the work environment based on the determined movement of the forest work machine, the determined attitude and/or the state of motion of the boom parts of the boom, the attitude and/or the state of motion of the tool, and on the dependence between the coordinate systems.

17. A control system according to claim 13,
wherein said at least one control means is configured to produce a control command for transferring the forest work machine in motion in the work environment keeping the tip of the boom supported on said object being stationary, whereby said at least one control unit is configured to
determine at least the position of the tip of the boom in the coordinate system of the work environment, the tip of the boom being supported on said stationary object,
determine at least the position of the tip of the boom in the coordinate system of the forest work machine, the tip of the boom being supported on said stationary object,
determine at least the attitude of the boom parts of the boom in the coordinate system of the forest work machine based on the position of the tip of the boom in the coordinate system of the forest work machine,
determine the movement of the forest work machine in the coordinate system of the work environment, and
convert the control command into at least one control measure of at least one actuator controlling the tip of the boom in at least one degree of freedom in the coordinate system of the forest work machine and/or at least one control measure controlling the movement of the forest work machine in the coordinate system of the work environment based on the determined attitude of the boom parts of the boom, the determined movement of the forest work machine and on the dependence between the coordinate systems.

18. A control system according to claim 13,
wherein said at least one control means is configured to produce a control command for transferring the forest work machine in motion in the work environment keeping the tip of the boom grabbing said object being stationary without substantially changing the attitude of the tool at the tip of the boom, whereby said at least one control unit is configured to
determine the position and direction of the tip of the boom in the coordinate system of the work environment, the tip of the boom grabbing said stationary object,
determine the position and direction of the tip of the boom in the coordinate system of the forest work machine, the tip of the boom grabbing said stationary object,
determine the attitude of the boom parts of the boom and the attitude of the tool in the coordinate system of the forest work machine based on the determined position and direction of the tip of the boom in the coordinate system of the forest work machine,
determine the movement of the forest work machine in the coordinate system of the work environment, and
convert the control command into at least one control measure of at least one actuator controlling the tip of the boom in at least one degree of freedom in the coordinate system of the forest work machine and/or at least one control measure controlling the movement of the forest work machine in the coordinate system of the work environment based on the determined attitude of the boom parts of the boom and the attitude of the tool, the determined movement of the forest work machine and on the dependence between the coordinate systems.
